(19) United States
(12) Patent Application Publication
(10) Pub. No.: US 2002/0104410 A1
(43) Pub. Date: Aug. 8, 2002

(54) Tool handle combination

(76) Inventor: Gin Din Wang, Taichung (TW)

Correspondence Address: Gin Din Wang, No. 108-24, Chong Chin Road, Bei Tun Chu, Taichung, 406, TW

(21) Appl. No.: 09/777,634

(22) Filed: Feb. 5, 2001

(51) Int. Cl. B25B 23/16

(52) U.S. Cl. 81/177.1

(57) ABSTRACT

A tool handle includes a handle stem having a tool member formed on one end and a hand grip device to be secured to the other end. A covering is secured in the peripheral portion of the hand grip device which includes two hand grip members each having a chamber for receiving the handle stem and having a peripheral wall. The covering is made of resilient materials and includes an upper portion and a lower portion each having a peripheral groove for receiving the peripheral walls of the hand grip members. The hand grip members each has a partition engaged with each other.

### BACKGROUND OF THE INVENTION

1. Field of the Invention

The present invention relates to a handle, and more particularly to a tool handle.

2. Description of the Prior Art

Typical tool handles, particularly the handles of the wrenches or screw drivers, comprise a rubber sleeve engaged onto one end of a handle stem and secured to the handle stem with fasteners. The rubber sleeve is made of soft or resilient rubber materials and may not be solidly secured to the handle stem with the fasteners.

The present invention has arisen to mitigate and/or obviate the afore-described disadvantages of the conventional tool handles.

### SUMMARY OF THE INVENTION

The primary objective of the present invention is to provide a tool handle combination including at least one soft or resilient covering member and two harder hand grip members secured together and solidly secured to the handle stem.

In accordance with one aspect of the invention, there is provided a tool handle combination comprising a handle stem including a first end having a tool member provided thereon, and including a second end, a hand grip device secured to the second end of the handle stem and including a peripheral portion, and a covering secured in the peripheral portion of the hand grip device.

The hand grip device includes a first and a second hand grip members each having a chamber formed therein for receiving the second end of the handle stem, and each having a peripheral wall for defining the chamber thereof.

The covering includes an upper portion and a lower portion each having a peripheral groove formed therein for receiving the peripheral walls of the first and the second hand grip members respectively.

The first and the second hand grip members each includes a curved fence provided therein, the covering includes two end portions each having a slot formed therein for receiving the curved fences of the first and the second hand grip members.

The first and the second hand grip members each includes a partition extended inward of the chamber thereof, the partitions of the first and the second hand grip members are engaged with each other.

The partitions of the first and the second hand grip members each includes a flange of a reduced width extended therefrom for defining a shoulder in each of the partitions of the first and the second hand grip members, the flanges of the first and the second hand grip members are engaged into the shoulders of the second and the first hand grip members respectively.

The partitions of the first and the second hand grip members each includes a U-shape having two legs for receiving the handle stem between the legs.

The first and the second hand grip members each includes at least one reinforcing rib extended inward of the chamber thereof and engaged with the handle stem.

At least one fastener is engaged through the first and the second hand grip members and through the handle stem for securing the first and the second hand grip members and the handle stem together, the second hand grip member includes an aperture formed therein for receiving the fastener and includes at least one opening formed therein and communicating with the aperture, and at least one cap engaged in the opening of the second hand grip member for covering the fastener.

The cap includes means for securing the cap to the second hand grip member. The second hand grip member includes at least one bulge extended inward of the chamber thereof, the aperture of the second hand grip member is formed in the bulge.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a tool handle combination in accordance with the present invention;

FIG. 2 is an exploded view of the tool handle combination;

FIG. 3 is a bottom perspective view showing a hand grip member of the tool handle combination;

FIG. 4 is a cross sectional view taken along lines 4-4 of FIG. 1; and

FIGS. 5 and 6 are cross sectional views taken along lines 5-5 and 6-6 of FIG. 4 respectively.

### DETAILED DESCRIPTION OF THE PREFERRED EMBODIMENT

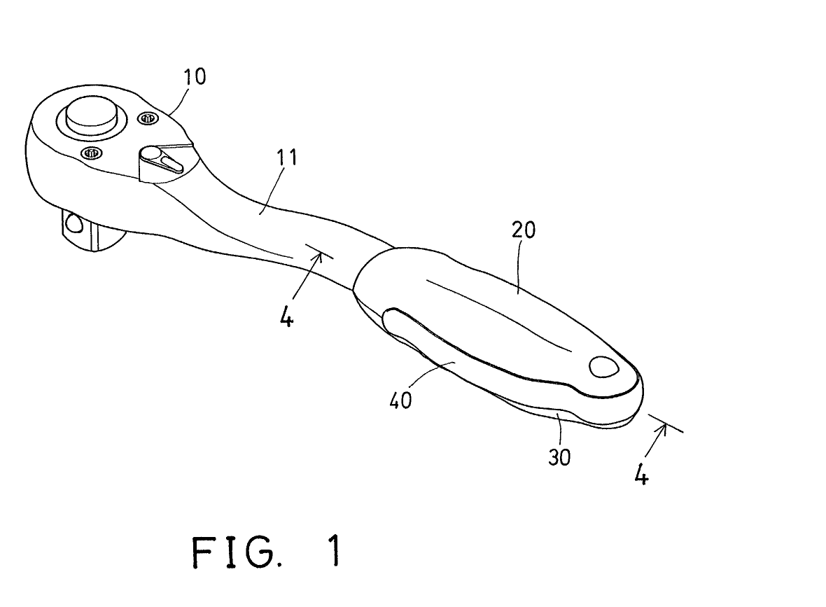

Referring to the drawings, and initially to FIGS. 1-4, a tool handle combination in accordance with the present invention comprises a handle stem 11 including one end having a tool member 10, such as a wrench member, a screw driver member, or the like provided thereon, and including two hand grip members 20, 3O and a cushioning member 40 to be secured to the other end 12 (FIG. 2) of the handle stem 11. The handle stem 11 includes one or more orifices 13 (FIG. 2) formed in the other end 12 thereof.

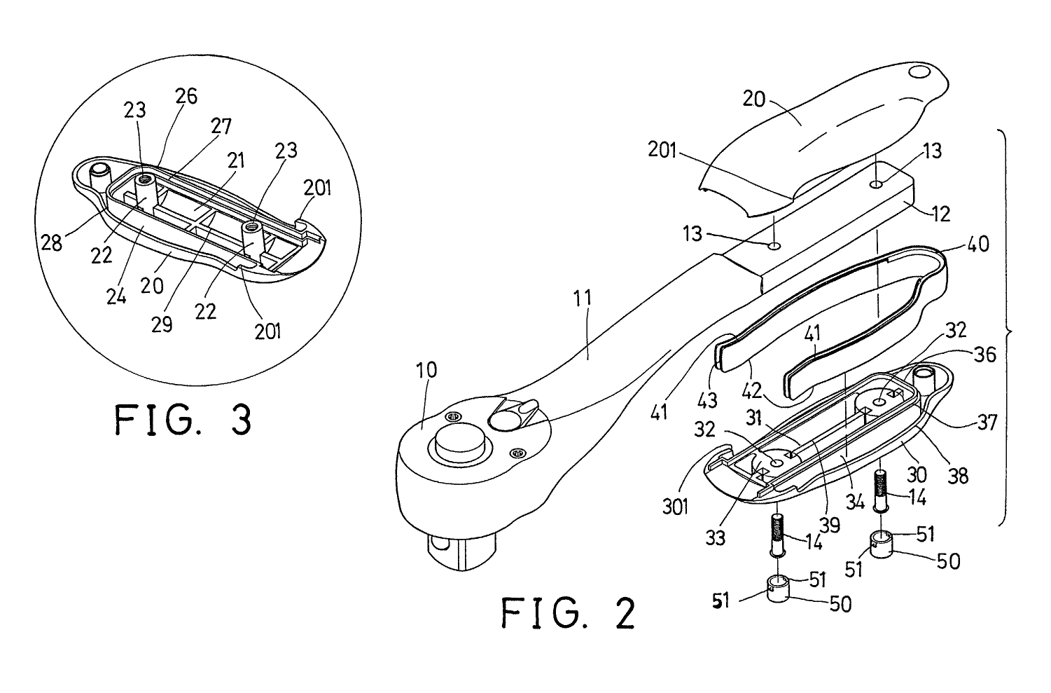

As shown in FIGS. 3-6, the hand grip member 20 includes a chamber 21 formed therein and defined by a peripheral wall 28 for receiving the other end 12 of the handle stem 11, and includes one or more pins 22 extended therefrom for engaging through the orifices 13 of the handle stem 11, and includes a partition member, such as a U-shaped peripheral partition 24 extended therein. The peripheral partition 24 includes a flange 26 having a reduced width extended upward therefrom for forming a shoulder or a peripheral shoulder 27 therein. The pins 22 each includes a screw hole 23 formed therein for threading with the fasteners 14. The hand grip member 20 further includes one or more reinforcing ribs 29 extended inward of the chamber 21 thereof for solidly engaging with the other end 12 of the handle stem 11 (FIG. 6). The handle stem 11 is preferably snugly engaged and retained between two legs of the U-shaped peripheral partition 24. The hand grip member 20 includes a pair of curved fences 201 formed in the front portion thereof.

The other hand grip member 30 also includes a chamber 31 formed therein and defined by a peripheral wall 33 for receiving the other end 12 of the handle stem 11, and includes one or more apertures 32 formed therein, such as formed in the bulges 33 that are extended inward of the chamber 31 of the hand grip member 30 for receiving the fasteners 14, and includes a partition member, such as a U-shaped peripheral partition 34 extended therein. The peripheral partition 34 includes a flange 36 having a reduced width extended upward therefrom for forming a shoulder or a peripheral shoulder 37 therein. The flanges 26, 36 of the hand grip members 20, 30 may be engaged with each other for solidly securing the hand grip members 20, 30 together. The hand grip member 30 further includes one or more reinforcing ribs 39 extended inward of the chamber 31 thereof. The reinforcing ribs 39 and the bulges 33 may be used for solidly engaging with the other end 12 of the handle stem 11 (FIG. 6). The handle stem 11 is preferably snugly engaged and retained between two legs of the U-shaped peripheral partition 34. The hand grip member 20 also includes a pair of curved fences 301 formed in the front portion thereof.

A soft or resilient covering 40 is to be engaged between the hand grip members 20, 30 and preferably made of plastic or rubber materials, and includes a substantially U-shaped structure having two peripheral grooves 41, 42 formed in the upper peripheral portion and the lower peripheral portion thereof, for receiving the peripheral walls 28, 38 of the hand grip members 20, 30 (FIG. 6), and includes two slots 43 formed in the front ends thereof for receiving the curved fences 201, 301 of the hand grip members 20, 30 respectively, such that the covering 40 may be solidly retained between the hand grip members 20, 30. The hand grip members 20, 30 may be made of harder materials, such as the plastic or metal materials, for solidly engaging with and securing to the handle stem 11.

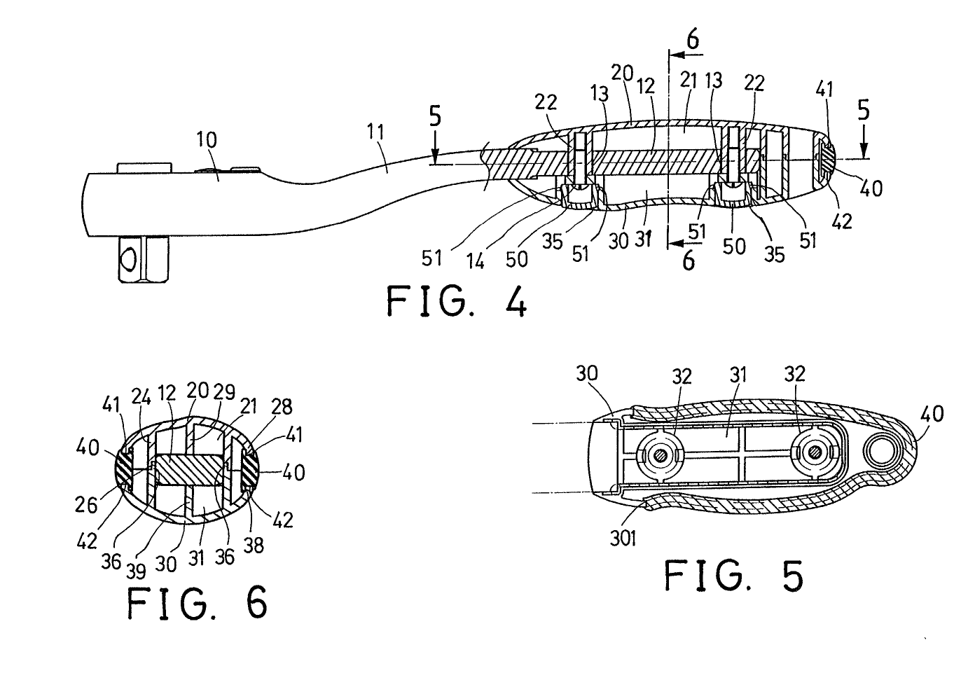

As shown in FIGS. 2 and 4, the hand grip member 30 includes one or more openings 35 formed in the bottom portion thereof and communicating with the apertures 32 thereof. One or more caps 50 are engaged in and secured to the openings 35 of the hand grip member 30 with such as the force-fitted engagement, and may further includes one or more hooks or latches 51 extended therefrom for engaging with the hand grip member 30 and for securing the caps 50 to the hand grip member 30. The caps 50 may be used for shielding the fasteners 14 (FIG. 4) and for preventing the fasteners 14 from being easily unthreaded from the hand grip member 30.

It is to be noted that the resilient covering 40 may be retained and secured between the hand grip members 20, 30 and are not required to be secured to the handle stem 11 by fasteners. In addition, the covering 40 may be made with the plastic materials of various colors or of various patterns, for decorative purposes. In operation, the hand of the users may hold and grasp the covering 40 and may feel comfortable to hold and grasp the tool handle. The hand grip members 20, 30 may also be formed as an integral one-piece hand grip device having the resilient covering 40 engaged therein.

Accordingly, the tool handle combination in accordance with the present invention includes at least one soft or resilient covering member and two harder hand grip members secured together and solidly secured to the handle stem.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A tool handle combination comprising:
a handle stem including a first end having a tool member provided thereon, and including a second end,
a hand grip device secured to said second end of said handle stem and including a peripheral portion, and
a covering secured in said peripheral portion of said hand grip device.

2. The tool handle combination according to claim 1, wherein said hand grip device includes a first and a second hand grip members each having a chamber formed therein for receiving said second end of said handle stem, and each having a peripheral wall for defining said chamber thereof.

3. The tool handle combination according to claim 2, wherein said covering includes an upper portion and a lower portion each having a peripheral groove formed therein for receiving said peripheral walls of said first and said second hand grip members respectively.

4. The tool handle combination according to claim 2, wherein said first and said second hand grip members each includes a curved fence provided therein, said covering includes two end portions each having a slot formed therein for receiving said curved fences of said first and said second hand grip members.

5. The tool handle combination according to claim 2, wherein said first and said second hand grip members each includes a partition extended inward of said chamber thereof, said partitions of said first and said second hand grip members are engaged with each other.

6. The tool handle combination according to claim 5, wherein said partitions of said first and said second hand grip members each includes a flange of a reduced width extended therefrom for defining a shoulder in each of said partitions of said first and said second hand grip members, said flanges of said first and said second hand grip members are engaged into said shoulders of said second and said first hand grip members respectively.

7. The tool handle combination according to claim 5, wherein said partitions of said first and said second hand grip members each includes a U-shape having two legs for receiving said handle stem between said legs.

8. The tool handle combination according to claim 2, wherein said first and said second hand grip members each includes at least one reinforcing rib extended inward of said chamber thereof and engaged with said handle stem.

9. The tool handle combination according to claim 1 further comprising at least one fastener engaged through said first and said second hand grip members and through said handle stem for securing said first and said second hand grip members and said handle stem together, said second hand grip member includes an aperture formed therein for receiving said at least one fastener and includes at least one opening formed therein and communicating with said at least one aperture, and at least one cap engaged in said at least one opening of said second hand grip member for covering said at least one fastener.

10. The tool handle combination according to claim 9, wherein said at least one cap includes means for securing said at least one cap to said second hand grip member.

11. The tool handle combination according to claim 9, wherein said second hand grip member includes at least one bulge extended inward of said chamber thereof, said at least one aperture of said second hand grip member is formed in said at least one bulge.
